(19) United States
(12) Patent Application Publication
(10) Pub. No.: US 2026/0119660 A1
(43) Pub. Date: Apr. 30, 2026

(54) MONITORING FILE WRITE OPERATIONS TO DETECT FILE ISSUES

(71) Applicant: HEWLETT PACKARD ENTERPRISE DEVELOPMENT LP, Spring, TX (US)

(72) Inventor: Tal Aloni, Herzliya (IL)

(21) Appl. No.: 18/929,785

(22) Filed: Oct. 29, 2024

(51) Int. Cl. G06F 21/56; G06F 16/178

(52) U.S. Cl. CPC G06F 21/565; G06F 16/178; G06F 2221/034

(57) ABSTRACT

A technique includes accessing file write operations that are provided by an operating system of a computer system. The file write operations are associated with a file. The technique includes determining an observed signature of the file based on the file write operations; and based on the observed signature, detecting an issue that is associated with the file. A responsive action is initiated in response to the detection of the issue.

### BACKGROUND

A computer system may be subject to a security attack for such purposes as seeking access to information or harming components of the computer platform. A computer system may have different levels of security protection for such purposes as detecting security attacks, preventing security attacks and mitigating harm inflicted by security attacks.

### BRIEF DESCRIPTION OF THE DRAWINGS

FIG. 1 is a block diagram of a continuous data protection system (CDP) that monitors file write operations to detect denylist files, according to an example implementation.

FIG. 2 is a file write operation monitoring architecture according to an example implementation.

FIG. 3 is an illustration of a technique to determine a file signature, according to an example implementation.

FIG. 4 is a flow diagram depicting file write operation processing according to an example implementation.

FIG. 5 is a flow diagram depicting a technique to monitor file write operations to detect an issue with a file, according to an example implementation.

FIG. 6 is an illustration of hardware processor-readable instructions that are stored on a non-transitory storage medium and when executed by a hardware processor, cause a continuous data protection system to determine whether a file is security-compromised based on hashes derived from file write operations associated with the file, according to an example implementation.

FIG. 7 is a block diagram of a computer system having a virtual replication appliance to determine whether a file has an issue based on hashes derived from file write operations directed to the file, according to an example implementation.

### DETAILED DESCRIPTION

A file may be security-compromised due to the file containing malware or the file having a security vulnerability. In either case, a security-compromised file exposes a computer system to security intrusions. In one approach to identify security-compromised files, software of a computer system scans the computer system's storage for files having file names that are on a denylist. This approach, however, may allow sufficient time for security intrusions originating with the files to develop and adversely impact the computer system. Moreover, the software may be operating system specific, and as such, this approach may be burdensome to implement in a computer system that has a large number of operating systems and operating system versions.

An operating system generates writes (also called "I/Os" and "write operations") for purposes of making changes to a file system. In examples, these changes include adding files, adding directories, changing directories and deleting files. The file system may be associated with a particular storage device (e.g., a virtual storage device), and for purposes of communicating with the storage device, the write operations comply with a particular storage device communication protocol. For example, to store a file in a Small Computer System Interface (SCSI) virtual storage device, the operating system generates a series of file write operations according to SCSI-based protocol (e.g., a serial-attached SCSI, or "SAS," protocol; a FibreChannel SCSI, or "FC-SCSI," protocol; an internet SCSI, or "iSCSI," protocol; or other SCSI protocol). Write operations directed to adding or replacing a file are referred to herein as "file write operations."

File write operations include respective units of data (also called "units" and "blocks" herein) which correspond to the file. In an example, each unit of data has a size that corresponds to a cluster size of a virtual storage device. The cluster size, in turn, is the minimum unit of readable and writable storage. In an example, a particular file write operation includes a unit of data that corresponds to metadata and which represents attributes of the file, such as a file name and a file creation date. In another example, file write operations include respective units of data corresponding to a content of the file.

In accordance with example implementations that are described herein, a file write monitoring architecture monitors file write operations for purposes of detecting denylist files. The file write monitoring architecture includes a monitoring agent (also called a "file write operation processing engine" herein) that observes operating system-provided file write operations. The monitoring agent determines a signature (called the "observed signature" herein) of a file based on observed file write operations that correspond to the file. The monitoring agent compares the observed signature to signatures (called "denylist signatures" herein) that are contained in a file denylist database. The denylist signatures correspond to respective files (or "denylist files") that have known, or recognized, issues. The monitoring agent, responsive to an observed file signature matching a denylist signature, generates an alert to a user interface to bring attention to the detection of the denylist file.

A "denylist" file, in the context that is used herein, refers to a file that is banned, or prohibited, from being stored or used on a particular computer system. Such a file may be known, or recognized, to be associated with an issue, such as security-related issue. In another example, a denylist file may be associated with a software defect, or "bug." In another example, a denylist file may correspond to a file version that is no longer supported (e.g., no longer supported by a business entity's information technology (IT) department or no longer support by a software vendor). A denylist file may be prohibited by a business enterprise from being stored or used on the enterprise's computer system for any of a number of other reasons.

In accordance with example implementations, the monitoring agent derives an observed signature for a file based on the file's content, as gathered, or observed, from file write operations that are generated by an operating system. Therefore, the observed signature captures any versioning of the file or any other variations that may not be captured merely by the file name or other file attribute information. More specifically, in accordance with example implementations, the observed signature is an ordered arrangement of hashes, which is referred to as a "hash sequence" herein. A "hash sequence" may also be referred to as a "hash chain." The monitoring agent, in accordance with example implementations, generates a hash sequence for a file as follows. The file write operations corresponding to the writing of the file to storage include a file write operation that is associated with the file's attributes and multiple other file write operations (called "file content-affiliated file write operations" herein) that are associated with the file's content. The monitoring agent processes the file content-affiliated file write operations for purposes of deriving the observed hash sequence for the file.

More specifically, each file content-affiliated file write operation includes a unit of data that represents a particular segment, or part, of the file, and each unit has an associated offset within the file. The monitoring agent applies a cryptographic hashing algorithm to each unit of data to derive a corresponding hash. The monitoring agent arranges the hashes in a particular sequence (called an "observed hash sequence" herein) corresponding to the associated offset order within the file. For example, a file's content may be represented by the following tuple of N units of data: <Unit₁, Unit ₂, . . . Unit_{N} >. In this example, Unit₁ corresponds to the first part of the file content (at an offset of "0"), Unit ₂ corresponds to the second part of the file content, and Unit_{N} corresponds to the last part of the file. Continuing the example, the monitoring agent determines a hash sequence, as represented by the following tuple: <Hash(Unit₁), Hash (Unit ₂), . . . Hash(Unit_{N})>.

In accordance with example implementations, a denylist database includes records that are associated with respective denylist files. Each record contains data representing a denylist hash sequence and representing identifying information for the associated denylist file. The monitoring agent compares the observed hash sequence to the denylist hash sequences of the denylist database for purposes of determining whether the observed hash sequence matches any of the denylist hash sequences.

In accordance with example implementations, the monitoring agent is a component of a virtual replication appliance of a continuous data protection (CDP) system. Unlike traditional backup methods that rely on periodic or scheduled backups, a CDP system provides a more granular and up-to-date protection of data in near real time. The CDP system includes a primary computer system (e.g., a production computer system) and a disaster recovery computer system. The primary computer system hosts a group (called a "virtual protected group" herein) of virtual machines. Each virtual machine has a guest operating system and an associated file system. In an example, a virtual machine has an associated virtual storage device that is mounted to the associated file system. The guest operating systems generate write operations that correspond to changes (e.g., file additions, file overwrites, directory modifications and file deletions) to the associated file systems. Some of the write operations are file write operations that correspond to the writing of files to the virtual storage devices. The virtual replication appliance, for each guest operating system, replicates the operating system's write operations and sends the replicated write transactions to the disaster recovery computer system. In this way, the disaster recovery system tracks changes to the filesystems of the virtual machines so that the virtual machines and their associated file systems may be restored on the disaster recovery system in the event that an outage (e.g., a network outage, a power outage or other outage) impacts virtual machine availability on the primary computer system.

Among the potential advantages, the file write monitoring architecture provides denylist file detection in near real time. Moreover, the file write monitoring architecture is operating system agnostic, as the monitoring agent is not tied to a specific operating system or operating system version.

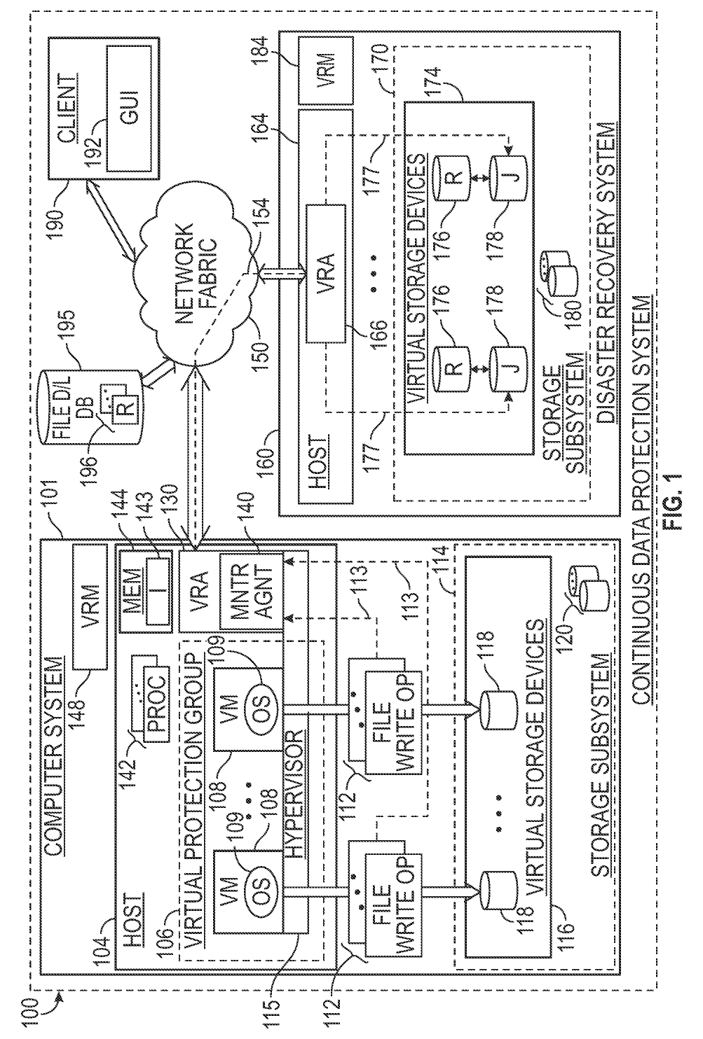

Referring to FIG. 1, as a more specific example, a CDP system 100, in accordance with some implementations, includes a primary computer system 101 (e.g., a production computer system) and a disaster recovery system 160 that are connected by a network fabric 150. In accordance with example implementations, the network fabric 150 may be associated with one or multiple types of communication networks, such as, in examples, Remote Direct Memory Access (RDMA) fabric, Fibre Channel fabric, InfiniBand fabric, Compute Express Link (CXL) fabric, dedicated management networks, local area networks (LANs), wide area networks (WANs), global networks (e.g., the Internet), wireless networks, or any combination thereof.

In an example, the primary computer system 101 and the disaster recovery system 160 correspond to respective datacenters that are located in different respective availability zones. In an example, the availability zones are in respective geographical regions that are sufficiently isolated such that an event in one geographical region, which causes an outage of a datacenter that is located in one availability zone, would not be expected to cause an outage for a datacenter that is located in the other availability zone.

As depicted in FIG. 1, the primary computer system 101 includes one or multiple hosts 104. In this context, a "host" refers to an entity that includes physical resources, such as hardware processors 142 and a system memory 144. A hardware processor 142 may include one or multiple processing cores (e.g., central processing unit (CPU) cores and/or graphics processing unit (GPU) cores). In general, the memory devices that form the system memory 144, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

In accordance with example implementations, the host 104 corresponds to a computer platform. In the context that is used herein, a "computer platform" is a modular unit, which includes a frame, or chassis; and hardware that is mounted to the chassis and is capable of executing machine-readable instructions. In an example, a computer platform may be a server, such as an enclosure-based server (e.g., a blade server), a rack server (e.g., a density line (DL) server), or a tower server.

The host 104 may provide a variety of application operating environments. In an example, a virtual machine manager (VMM), or hypervisor 115, of the host 104 provides machine level abstractions called "virtual machines 108." In general, the virtual machine 108 is a virtual abstraction of hardware and software resources of the host 104. A virtual machine 108 has its own abstraction (called a "guest operating system 109") of a host operating system. The hypervisor 115 manages the lifecycles (e.g., the deployment and termination) of the virtual machines 108.

Each virtual machine 108 is associated with a file system. Moreover, one or multiple virtual storage devices may be mounted to the file system. For the example implementation that is depicted in FIG. 1, each virtual machine 108 is associated with a single exemplary virtual storage device 118. In another example, a given virtual machine 108 may be associated with multiple virtual storage devices. In the context that is used herein, a "file system," refers to a method and data structure to organize a collection of files. In the context that is used herein, a "file" refers to a container of information. In an example, a file system may be a virtual file system. In an example, the virtual file system may be an upper file system layer of a composite file system that includes lower layer physical file systems that are accessed through the virtual file system. In an example, files in a file system may be organized using a directory, which is a hierarchical structure, or tree; and the location of a file within the file system may be identified by a corresponding file path.

A guest operating system 109 generates write operations for purposes of making changes to the virtual machine's file system. FIG. 1 illustrates a specific type of write operation, a file write operation 112. In general, each guest operating system 109 generates file write operations 112 for purposes writing files to its associated virtual storage device 118. In an example, a guest operating system 109 generates a series of file write operations 112 in accordance with a storage device protocol (e.g., a SCSI-based protocol) for purposes of adding a file to a virtual storage device 118. In another example, a guest operating system 109 generates a series of file write operations 112 in accordance with a storage device protocol for purposes of overwriting an existing file that is stored on a virtual storage device 118.

The virtual machines 108 are part of a virtual protection group 106. Although FIG. 1 depicts a single virtual protection group 106, in accordance with further implementations, the primary computer system 101 includes multiple virtual protection groups 106. In an example, a particular application may include multiple microservices, and each microservice may correspond to a particular virtual machine 108 (e.g., a worker node of an orchestrated container cluster). For example, each virtual machine 108 may host container pods corresponding to multiple respective instances of the microservice. In an example, a single virtual protection group 106 corresponds to the entire application. In another example, virtual protection groups 106 correspond to different parts of the application. In an example, one virtual protection group 106 contains virtual machines 108 related to a front-end of the application, and another virtual protection group 106 contains virtual machines 108 related to a back-end part of the application.

In general, the CDP system 100 replicates each guest operating system's write operations and sends the replicated write transactions to the disaster recovery computer system 160. As described further herein, via the replicated write transactions, the disaster recovery system 160 tracks changes to the file systems of the virtual machines 108 so that the virtual machines 108 and their associated file systems may be restored on the disaster recovery system 160 (or even on another computer system) in the event that an outage impacts the availabilities of the virtual machines 108 on the primary computer system 101.

For purposes of replicating write operations and sending the replicated write operations to the disaster recovery system 160, the primary computer system 101 hosts a virtual replication appliance 130. The virtual replication appliance 130 observes write operations (including the file write operations 112) by the guest operating systems 109, as depicted by respective monitoring paths 113. The virtual replication appliance 130 replicates the write operations, and, as depicted by replication path 154, the virtual replication appliance 130 asynchronously sends the replicated write operations over the network fabric 150 to a virtual replication appliance 166 that is hosted by the disaster recovery system 160. In an example, the virtual replication appliance 130 is a virtual machine that is managed by the hypervisor 115, and the virtual replication appliance 130 has hooks into the hypervisor's storage stacks for purposes of monitoring writes by the guest operating systems 109. In an example, the virtual replication appliance 130 communicates the replicated write operations to the virtual replication appliance 166 using an over-fabric storage device protocol (e.g., an iSCSI protocol).

The virtual replication appliance 166 of the disaster recovery system 160 writes the replicated write operations for a particular virtual machine 108 to a respective journal 178, as depicted by a communication path 177. In addition to storing replicated write operations for the corresponding virtual machine 108 in the journal 178, the virtual replication appliance 166 updates the journal 178 with checkpoint timestamps. An end user may, via a graphical user interface (GUI) 192 of a client device 190, select a particular checkpoint timestamp for purposes of recovering a virtual machine 108 to a particular time. In this manner, recovering the virtual machine 108 includes the virtual replication appliance 168 applying replicated write operations that have timestamps that are before the selected checkpoint timestamp for purposes of constructing the virtual machine's file system on the disaster recovery system 160. The constructed file system corresponds to the file system of the virtual machine 108 before the time corresponding to the selected checkpoint timestamp, and the virtual machine 108 may then be restarted on the disaster recovery system 160 and use the constructed file system.

The virtual replication appliance 166 stores replicated write operations and checkpoint timestamps to a journal 178 until the journal 178 reaches a specified size (e.g., a user-specified journal size option, such as one week or one month). When this occurs, the virtual replication appliance 166 writes older replicated write operations from the journal 178 to a recovery virtual storage device 176 as newer replicated write operations are received from the virtual replication appliance 130 of the primary computer system 101. Therefore, recovering a virtual machine 108 after the journal 178 reaches the specified size includes beginning with the recovery virtual storage device 176 and applying replicated write operations from the journal 178, which have timestamps that are before the selected checkpoint timestamp.

In accordance with example implementations, the virtual replication appliance 130 of the primary computer system 101 includes a file write operation monitoring agent 140 (called the "monitoring agent 140" herein). The file write operation monitoring agent 140 may also be referred to as a "file write operation processing engine." The monitoring agent 140 observes file write operations 112 that are provided by the guest operating systems 109 and determines, based on the file write operations 112, observed signatures for files that are written to storage. The monitoring agent 140 checks the observed signatures against denylist signatures of denylist files, which have known, or recognized, issues. In the following discussion, it is assumed that the monitoring agent 140 checks the observed signatures against denylist signatures that are contained in a single file denylist database 195. In accordance with further implementations, the monitoring agent 140 checks the observed signatures against multiple file denylist databases (e.g., file denylist databases associated with different types, or categories, of file issues; multiple file denylist databases from different sources; or a combination of file denylist databases corresponding to different sources and different file issue categories). As depicted in the example implementation of FIG. 1, the file denylist database 195 is connected to the primary computer system 101 via the network fabric 150. The monitoring agent 140, in accordance with example implementations, stores and thereafter accesses a local copy of the file denylist database 105 (e.g., a local copy stored on the host 104).

The file denylist database 195, in general, contains records 196 that are associated with respective denylist files that have known, or recognized, issues. A record 196 contains data representing a denylist signature of the associated denylist file and further contains data representing information about the denylist file (e.g., a file name, a file size, a file creation date, a vendor name, or other information). In an example, the file denylist database 195 contains a collection of records 196 that are associated with respective denylist files that are recognized to have security-related issues, such as files that are recognized to have security vulnerabilities or contain malware. In another example, the file denylist database 195 contains a collection of records 196 that are associated with denylist files that are recognized to have non-security-related issues (e.g., software defects, files that are unsupported by a business entity's information technology IT department, files that are no longer support by a software vendor, files that are prohibited from being used on the primary computer system 101 per a business enterprise's policy and so forth).

The monitoring agent 140, responsive to determining that the observed signature of a file matches a denylist signature, initiates one or multiple responsive actions. In an example, the monitoring agent 140, via a web application programming interface (API) call, causes an alert message to be displayed on the GUI 192. In an example, the alert message may be a graphical display of information about the type of issue (e.g., a prohibited file, a file having a security-related issue, or other issue category), a time of detection, an identifier for the affected virtual machine, a file name and a file path. In another example, the file has a security-related issue, the monitoring agent 140 causes an alert message to be displayed on the GUI 192, and the monitoring agent 140 notifies a management controller (e.g., a baseboard management controller) associated with the host 104.

In an example, a virtual storage device 118 is a virtual block storage device that is associated with a SCSI-based protocol. For purposes of a guest operating system 109 writing a file to the virtual storage device 118, a driver (e.g., a SCSI driver or an iSCSI driver) of the guest operating system 109 generates file write operations 112 for purposes of storing data in a designated region of virtual memory associated with a virtual host bus adapter (HBA) of the virtual storage device. The file write operations 112 includes file content-affiliated file write operations 112 that contain respective units of data (also called "blocks" herein) that represent the content of the file. The monitoring agent 140 processes the data units for purposes of determining an observed signature of the file.

Among the other features of the CDP system 100, the primary computer system 101 includes a storage subsystem 114 . The storage subsystem 114 includes physical storage devices 120 (e.g., block storage devices) that provide the underlying storage for a collection of virtual storage devices 118, including the virtual storage devices 118. In an example, the physical storage devices 120 may be part of a storage area network (SAN)-based storage subsystem or a LAN-based storage subsystem. In a similar manner, the disaster recovery system 160 includes a storage subsystem 170 that includes physical storage devices 180 that provide the underlying storage for a collection 174 of virtual storage devices, including the replicas 176 and the journals 178.

In accordance with example implementations, the primary computer system 101 includes a virtual replication manager 148, and the disaster recovery system 160 includes a virtual replication manager 184. The virtual replication managers 148 and 184 set up and orchestrate the write operation replication. More specifically, the virtual replication manager 148 configures virtual protection groups (e.g., the virtual protection group 106) of the primary computer system 101, including launching virtual replication appliances (e.g., the virtual replication appliance 130) for the virtual protection groups. Moreover, for each virtual protection group, the virtual replication manager 148 coordinates with the virtual replication manager 184 to launch a corresponding virtual replication manager (e.g., the virtual replication manager 148) on the disaster recovery system 160.

In accordance with example implementations, software components of the CDP protection system 100 are formed by actual, or physical, hardware processors executing hardware processor-readable instructions. In an example, one or multiple hardware processors 142 of the host 104 execute instructions 143 that are stored in the memory 144 for purposes of forming one or multiple software components of the primary computer system 101, such as the virtual machines 108, the virtual replication appliance 130, the monitoring agent 140, and the virtual replication manager 148.

As used herein, an "engine," such as the file write operation processing engine (also called the "monitoring agent 140" herein) can refer to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. In an example, instructions 143 that are stored in the memory 144 may be executed by one or multiple hardware processors 142 to cause the hardware processor(s) 142 to perform one or multiple functions for the file write operation processing engine. Alternatively, an "engine," in accordance with further implementations, such as the file write operation processing engine, may be solely limited to one or multiple hardware processing circuits that do not execute machine-readable instructions. In another variation, the file write operation processing engine is a combination of one or multiple hardware processing circuits that do not execute machine-readable instructions and hardware processors that execute machine-readable instructions.

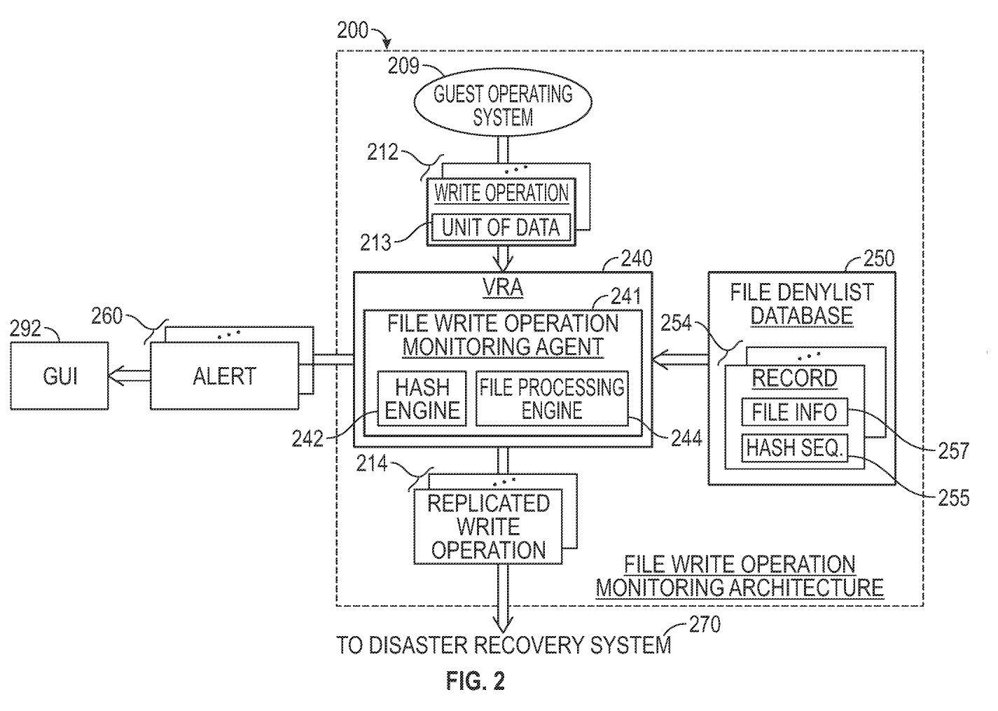

FIG. 2 depicts a file write operation monitoring architecture 200 in accordance with example implementations. The file write operation monitoring architecture 200 includes a file write monitoring agent 241 (called a "monitoring agent 241" or "file write operation processing engine" herein) and a file denylist database 250. The monitoring agent 241 is a component of a virtual replication appliance 240. The monitoring agent 140, the file denylist database 195 and the virtual replication appliance 130 of FIG. 1 are examples of the monitoring agent 241, the file denylist database 250 and the virtual replication appliance 240, respectively.

The monitoring agent 241 includes a file processing engine 244, which monitors write operations 212 that are generated by a guest operating system 209. The guest operating system 109 of FIG. 1 is an example of the guest operating system 209. In general, the virtual replication appliance 240 replicates the write operations 212 for purposes of producing replicated write operations 214 that are sent, by the virtual replication appliance 240, to a disaster recovery system, as depicted at 270.

As depicted in FIG. 2, each write operation 212 includes a unit 213 of data (also referred to herein as a "block" or "data block") to be written to a file system. In accordance with example implementations, the unit 213 corresponds to a minimum unit of storage and may alternatively be referred to as a "cluster." In an example, a storage system block size is 512 bytes; cluster size of the storage system is a multiple of the storage system block size, such as 4096 bytes; and the unit 213 of data has a size of 4096 bytes.

Some write operations 212 may be directed to changes to the file system, which do not correspond to writing, or storing, a file. For example, a particular write operation 212 may be directed to a modification to a file system directory. Other write operations 212 may target files but may not be directed to writing a file to the file system. For example, a particular write operation 212 may be directed to deleting a file. The file processing engine 244, in accordance with example implementations, sorts the write operations 212 for purposes of identifying write operations 212 (called "file write operations" herein) that are directed to writing files. Moreover, the file processing engine 244 further identifies file write operations (called "file content-affiliated write operations" herein) that contain units 213 of data corresponding to file content.

The file processing engine 244, in accordance with example implementations, determines an observed signature for a file based on the units 213 of data contained in file content-affiliated write operations for the file. More specifically, in accordance with example implementations, the file processing engine 244 uses a hash engine 242 of the monitoring agent 241 to apply a cryptographic hash algorithm to each unit 213 of data. The file processing engine 244 combines the hashes for a given file into a sequence (called an "observed hash sequence" herein) that corresponds to an observed signature for the file. The file processing engine 244 compares the observed hash sequence to records 254 of a file denylist database 250. Each record 254 includes data representing a denylist hash sequence 255 for a corresponding denylist file that has a known, or recognized, issue. As depicted in FIG. 2, each record 254 further includes data representing information 257 about the denylist file. In an example, the information 257 may represent a file name, a file creation date, a software vendor, as well as other and/or different information.

The file processing engine 244 checks each observed hash sequence against the records 254 for purposes of determining whether there is a hash sequence match. In this context, an observed hash sequence "matching" a hash sequence 255 of the file denylist database 250 refers to the observed hash sequence matching at least a prefix of the denylist hash sequence 255. In this context, a "prefix" of the denylist hash sequence 255 refers to a beginning of the denylist hash sequence 255 less than the full denylist hash sequence 255.

In an example, an observed hash sequence of P hashes arranged in an order from hash H_{OBS-1} to hash H_{OBS-P} may be represented by the following tuple:

<H_{OBS-1}, H_{OBS-2}, . . . H_{OBS-P}>_{OBSERVED}

The order of the hashes of the observed hash sequence corresponds to the order in which the corresponding data units 213 appear in the file. A denylist hash sequence 255 of M hashes arranged in an order from hash H_{DL-1} to hash H_{DL-P} of the file denylist database 250 may be represented by the following tuple:

<H_{DL-1}, H_{DL-2}, . . . H_{DL-M}>_{DENYLIST}

In an example, the number P of hashes of the observed hash sequence equals the number M of hashes of the hash sequence 255; and the file processing engine 244 determines that a match occurs if all of the hashes match (i.e., H_{OBS-1}= H_{DL-1,} H_{OBS-2}= H_{DL-2}, . . . and H_{OBS-P}= H_{DL-M}). In another example, the number P of hashes of the observed hash sequence is less than the number M of hashes of the hash sequence 255. Stated differently, for this example, the observed hash sequence corresponds to a prefix of the denylist hash sequence. Moreover, for this example, the file processing engine 244 determines that a match occurs if the hashes of the observed hash sequence are the same as respective hashes of the first P hashes of the hash sequence 255 (i.e., H_{OBS-1}= H_{DL-1,} H_{OBS-2}= H_{DL-2}, . . . and H_{OBS-P}= H_{DL-P}). The latter scenario may occur, for example, if the file content of the last file content-affiliated file write operation does not correspond to a full cluster, and the file processing engine 244 may determine to omit the hash from the observed hash sequence. In an example, the file processing engine 244 ends each observed hash sequence with the hash corresponding to the next to last part of the file. In another example, the file processing engine 244 does not determine hashes for all parts of the file in accordance with a policy. For example, an observed hash sequence generation policy limits the number of hashes of an observed hash sequence to an upper threshold (e.g., the policy specifies that the observed hash sequence is limited to the first five hashes).

The file processing engine 244, responsive to a hash sequence match, generates a corresponding alert 260. For the example implementation depicted in FIG. 2, the file processing engine 244 sends the alert 260 to a GUI 292. The GUI 192 of FIG. 1 is an example of the GUI 292. The file processing engine 244 may initiate different and/or other responsive actions in response to a hash sequence match, in accordance with further implementations. For example, for a hash sequence match corresponding to a denylist file that has a security-related issue, the file processing engine 244 may send a notification to a management controller (e.g., a baseboard management controller) or perform another action.

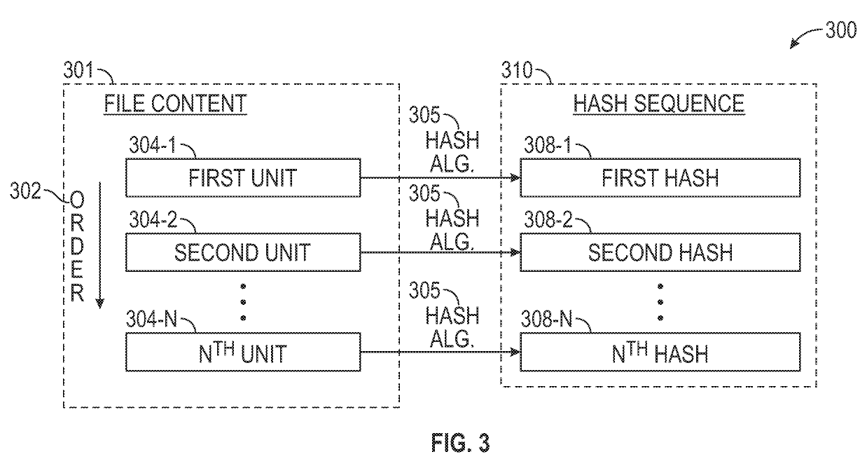

FIG. 3 is an illustration 300 of the generation of a hash sequence 310 for a file. In an example, the hash sequence 310 is an observed hash sequence constructed from file content-affiliated write operations by a file write operation monitoring agent (or "file write operation processing engine"), such as the file write operation monitoring agent 241 of FIG. 2.

The file content-affiliated write operations contain respective units 304 of data. In an example, the units 304 of data correspond to respective file write operations. The units 304 of data correspond to different segments, or parts, of a file content 301 of the file. The file content 301 has a certain order 302 for its constituent parts, and the units 304 of data follow the order 302. In an example, the first unit 304-1 of data corresponds to a file write offset of "0," the second unit 304-2 of data corresponds to a file write offset of U_{SIZE} (where "U_{SIZE}" represents the size of the unit 304, such as a cluster size), and the N-th unit 304-N of data corresponds to a file write offset of (N-1)∙U_{SIZE}.

For the example depicted in FIG. 3, the hash sequence 310 has N hashes 308 that are derived from the N data units 304. As described herein, the file content 301 may include N data units or may include more than N data units 304. As depicted at 305, the individual hashes 308 of the hash sequence 310 are created by applying a hash algorithm to individual units 304 of data. The hashes 308 are arranged in the hash sequence 310 according to the order 302. In this manner, the file write operation monitoring agent derives the first hash 308-1 of the hash sequence 310 by applying a hash algorithm to the first unit 304-1 of data, derives the second hash 308-2 of the hash sequence 310 applying the hash algorithm to the second unit 304-2 of data, and so forth.

In another example, the hash sequence 310 is a denylist hash sequence that corresponds to a particular denylist file and is contained in a record of a file denylist database. For this example, the denylist hash sequence 310 may be derived directly from the denylist file. In this manner, the units 304 are not derived from file write operations, but rather, directly correspond to and are derived from chunks of data read from the denylist file at different read offsets.

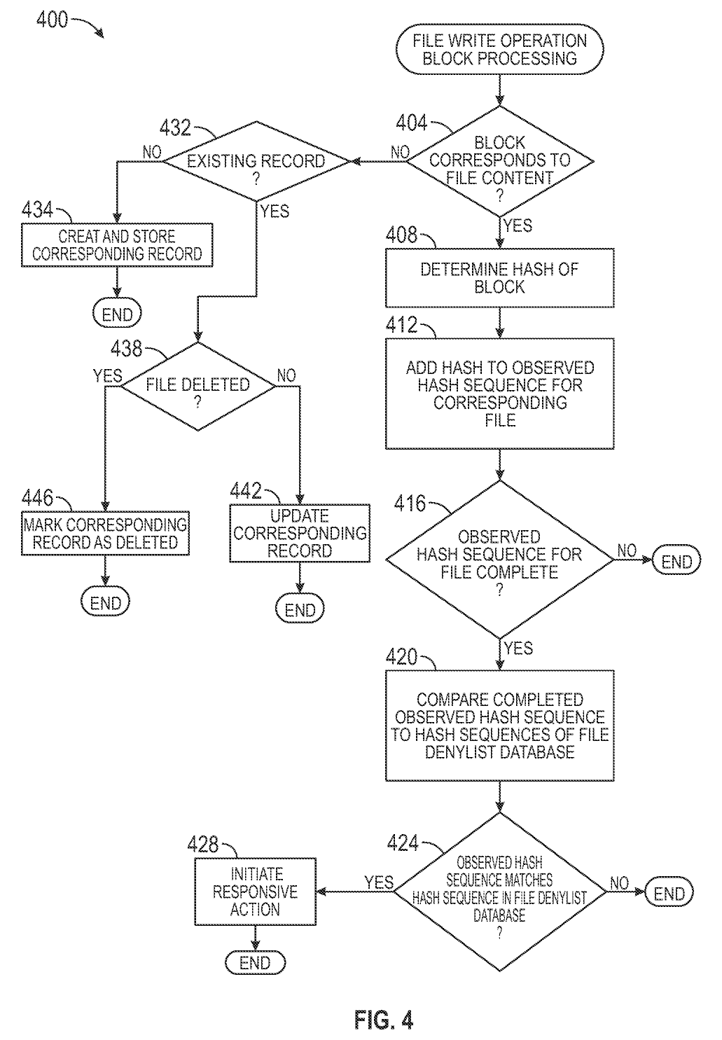

FIG. 4 depicts an example technique 400 to process a unit of data, or block, associated with a file write operation, in accordance with example implementations. In an example, the technique 400 may be performed by a monitoring agent (also called a "file write operation monitoring agent," or "file write operation processing engine"), such as the monitoring agent 140 of FIG. 1 or the monitoring agent 241 of FIG. 2. It is noted that the monitoring agent performs multiple iterations of the technique 400 for purpose of deriving an observed hash sequence for a file that is written by the operating system to storage. Each iteration corresponds to the monitoring agent processing a file write operation related to the file write.

Referring to FIG. 4, the processing of a block for a given file write operation first includes the monitoring agent determining (block 404) whether the block corresponds to file content. In an example, the monitoring agent inspects the block to determine whether the block contains filesystem metadata. In an example, the monitoring agent determines whether the block contains filesystem metadata by inspecting the structure of the data and determining whether the data has a characteristic filesystem metadata signature. If the data does not have a filesystem metadata signature, then the block contains file content.

If, pursuant to decision block 404, the monitoring agent determines that the block does not correspond to file content (i.e., determines the block contains filesystem metadata), then the monitoring agent determines (decision block 432) whether the corresponding file is associated with an existing file record that is maintained by the monitoring agent 141. For example, the block may correspond to a file that is being added to the file system. If, pursuant to decision block 432, the block does not correspond to an existing file record, then the monitoring agent creates and stores (block 434) the corresponding file record. If the block corresponds to an existing file record, then the monitoring agent makes the additional determination (decision block 438) of whether the block contains data representing that the file has been deleted. If the file has been deleted, then the monitoring agent marks (block 446) the corresponding file record as being deleted (without actually deleting the file record). Otherwise, if the file has not been deleted (decision block 438), then the monitoring agent updates (block 442) the corresponding file record with the attribute information from the block.

If, pursuant to decision block 404, the monitoring agent determines that the block contains file content, then, as depicted in block 408, the monitoring agent determines a hash of the block and adds (block 412) the hash to an observed hash sequence for the corresponding file. In another variation, the monitoring agent may be configured by a policy to determine observed hash sequences for certain file types. In an example, the monitoring agent may not determine observed hash sequences except for files that have one or multiple of the following file types (as set by policy): library files (e.g., .dll files), executable files (e.g., .exe files) or system files (e.g. .sys files).

In accordance with example implementations, if the block contains file content, then the monitoring agent (in addition to determining a hash of the block) records the location of the block. This facilitates locating the file should the file being determined to be a denylist file.

As noted above, the observed hash sequence is constructed in multiple iterations of the technique 400. Pursuant to decision block 416, the monitoring agent determines whether the observed hash sequence is complete. If not, then the technique 400 ends, as the hash sequence is to be completed in a future iteration of the technique 400. The monitoring agent may determine whether the observed hash sequence is complete based on a number of different factors. In an example, a policy may specify that each observed hash sequence is limited to a certain number of hashes, and the monitoring agent determines that the observed hash sequence is complete responsive to the number of hashes being reached. In another example, the monitoring agent determines that the observed hash sequence is complete responsive to all file content blocks for the file being processed and converted into hashes. In another example, the monitoring agent determines that the observed hash sequence is complete responsive to all file content blocks for the file except for the last file content block being processed and converted into hashes.

If, pursuant to decision block 416, the monitoring agent determines that the observed hash sequence for the file is complete, then the monitoring agent determines whether there is a known, or recognized, issue with the file. More specifically, pursuant to block 420, the monitoring agent compares the completed observed hash sequence to the denylist hash sequences of a file denylist database for purposes of identifying a hash sequence match. In an example, the monitoring agent determines that a hash match occurs when the observed hash sequence matches a prefix of a denylist hash sequence less than the full denylist hash sequence. In another example, the monitoring agent determines that a hash match occurs when the observed hash sequence matches a complete, nontruncated denylist hash sequence.

If the monitoring agent determines (decision block 424) that the observed hash sequence matches a hash sequence in the file denylist database, then the monitoring agent initiates a responsive action, as depicted in block 428. The particular responsive action may be set by a policy. For example, depending on the policy, the monitoring agent may alert a user to the detected denylist file and/or initiate one or other responsive actions.

In the context that is used herein, a "hash" (which may also be referred to by such terminology as a "digest," "hash value," or "hash digest") is produced by the application of a cryptographic hash algorithm to an input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address). In such an example, based on the string of data, the cryptographic hash algorithm outputs a hexadecimal string (the digest, or hash). Any minute change to the input value alters the output hexadecimal string. In examples, the cryptographic hash function may be a secure hash algorithm (SHA), a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

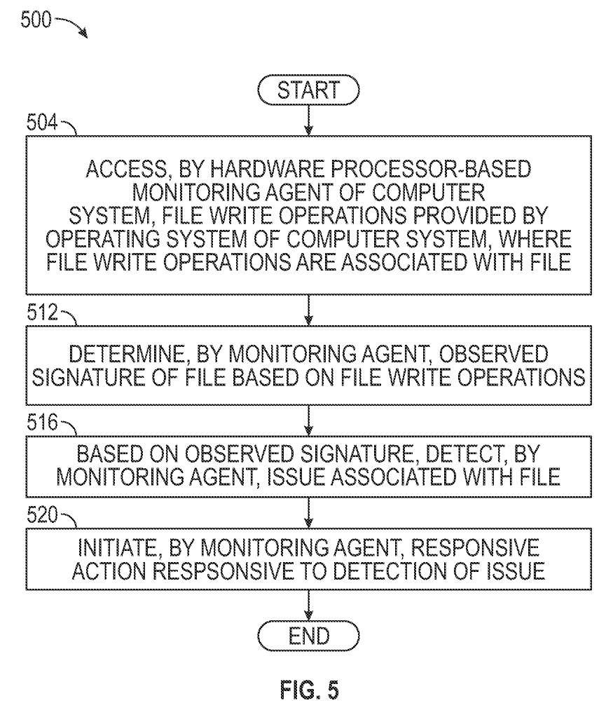

Referring to FIG. 5, in accordance with example implementations, a technique 500 includes accessing (block 504), by a hardware processor-based monitoring agent of a primary computer system, file write operations that are provided by an operating system of the computer system. The file write operations are associated with a file.

In an example, the operating system is a guest operating system of a virtual machine that is hosted by the primary computer system. In an example, the monitoring agent is component of a virtual replication appliance of the computer system. In an example, the virtual replication appliance is a virtual machine that is hosted by the computer system. In an example, the operating system is a guest operating system of a virtual machine that is managed by a hypervisor, and the monitoring agent is associated with a virtual machine that is hosted by the same hypervisor.

In an example, the file write operations are directed to a file system that is associated with a virtual machine, and the operating system is a guest operating system of the virtual machine. In an example, the file system is associated with a virtual storage device, and the file write operations correspond to the guest operating system writing the file to the virtual storage device. In an example, a SCSI-based driver of the guest operating system provides the file write operations for purposes of writing a file to a virtual block storage-based device.

In an example, a replication appliance of the computer system sends replications of the file write operations to a recovery system that is associated with the primary computer system. In an example, the primary computer system and the recovery system are part of a CDP system. In an example, the replication appliance is a first virtual machine, the operating system is a guest operating of a second virtual machine, and the first and second virtual machines are managed by the same hypervisor.

The technique 500 includes, pursuant to block 512, determining, by the monitoring agent, an observed signature of the file based on the file write operations. In an example, the observed signature is a hash sequence. In an example, determining the hash sequence includes applying a hash algorithm to data units associated with respective file write operations to determine corresponding hashes, and ordering the hashes. In an example, the units correspond to respective parts of a file content, and the hashes appear in the hash sequence in same order that the parts appear in the file content.

The technique 500 includes, pursuant to block 516, based on the observed signature, detecting, by the monitoring agent, an issue that is associated with the file. In an example, the file has a known, or recognized, security vulnerability. In another example, the file is associated with malware. In another example, the file has a known, or recognized, software defect. In another example, the file is not supported by an IT department, the file is no longer supported by the file's software vendor or the file is otherwise prohibited from being stored on the primary computer system.

In an example, detecting the issue includes searching a denylist database for a signature that matches the file's observed signature. In an example, searching the denylist database includes searching records corresponding to files that have known, or recognized issues. In an example, detecting the issue includes comparing an observed hash sequence for the file to hash sequences corresponding to files that have known, or recognized, issues. In an example, the observed signature is an observed hash sequence, the signatures of the denylist database are hash sequences, and the observed hash sequence matching a hash sequence of the denylist database includes the observed hash sequence corresponding to a lesser subpart of the hash sequence of the denylist database. In another example, the observed hash sequence matching a hash sequence of the denylist database includes the observed hash sequence entirely matching the hash sequence of the denylist database.

The technique 500 includes initiating (block 520), by the monitoring agent, a responsive action responsive to the detection of the issue. In an example, initiating the responsive action includes the monitoring agent sending a notification of the issue to a user interface. In an example, initiating the responsive action includes the monitoring agent notifying a management controller of the computer system.

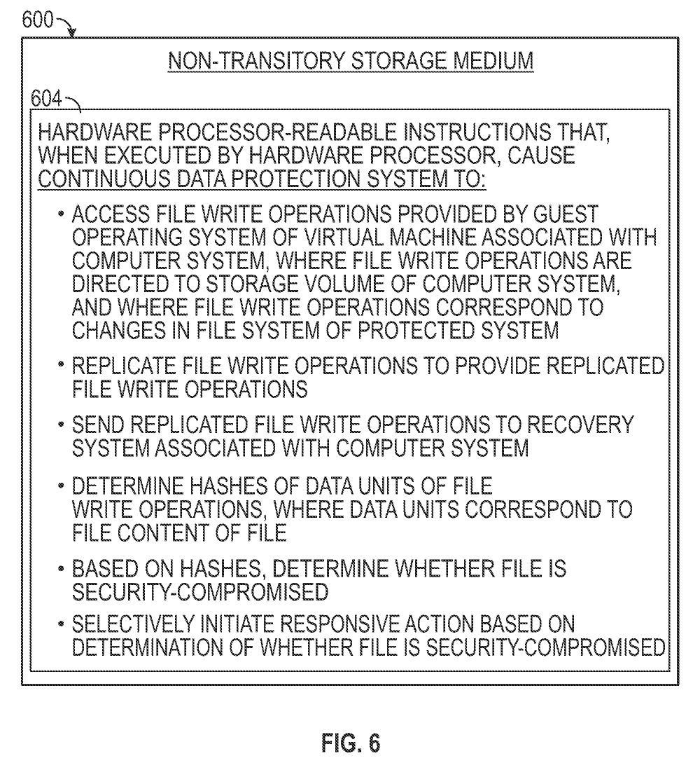

Referring to FIG. 6, in accordance with example implementations, a non-transitory storage medium 600 stores hardware processor-readable instructions 604. The instructions 604, when executed by a hardware processor, cause a continuous data protection system to access file write operations that are provided by a guest operating system of a virtual machine that is associated with a computer system. The file write operations are directed to a storage volume of the computer system, and the file write operations correspond to a file of the computer system.

In an example, the hardware processor includes one or multiple physical processing cores, such as one or multiple CPU cores. In an example, the storage volume corresponds to a virtual storage device associated with the virtual machine. In an example, the guest operating system provides the file write operations for purposes of storing the file in the virtual storage device. In an example, the file write operations correspond to writes by the guest operating system to a region of memory associated with the virtual storage device. In an example, the virtual storage device is a block storage device. In an example, the virtual storage device is a SCSI-based storage device. In an example, the SCSI-based protocol is an SAS protocol, a FC-SCSI protocol, or an iSCSI protocol. In an example, the file write operations are associated with units of data corresponding to the content of the file. In an example, the continuous data protection system provides protection of data associated with the virtual machine in near real time.

The instructions 604, when executed by the hardware processor, further cause the continuous data protection system to replicate the file write operations to provide replicated file write operations and send the replicated file write operations to a recovery system associated with the computer system. In an example, the recovery system is a disaster recovery system. In an example, the disaster recovery system includes a replication appliance that maintains a journal having data representing changes to the virtual machine's file system. In an example, the virtual replication appliance of the disaster recovery system writes replicated write operations for the virtual machine to the journal. The virtual replication appliance, in addition to storing replicated write operations for the virtual machine in the journal, updates the journal with checkpoint timestamps. In an example, an end user may select a particular checkpoint timestamp for purposes of recovering the virtual machine to a particular time. In an example, recovering the virtual machine includes applying replicated write operations that have timestamps that are before the selected checkpoint timestamps for purposes of constructing a file system on the disaster recovery system corresponding to the virtual machine. In an example, the virtual replication appliance of the disaster recovery system stores replicated write operations and checkpoint timestamps to the journal until the journal reaches a specified size. In an example, when this occurs, the virtual replication appliance of the disaster recovery system writes older replicated write operations from the journal to a recovery virtual storage device as newer replicated write operations are received.

The instructions 604, when executed by the hardware processor, further cause the continuous data protection system to determine hashes of respective data units of the file write operations. The data units correspond to a file content of the file. In an example, determining a hash of a data unit includes applying a hash algorithm to the data unit. In an example, the hashes may be determined by a hash engine of a file write monitoring agent. In an example, the hash algorithm may be an SHA-based algorithm. In another example, the hash algorithm may be a FIPS-based hash algorithm. In another example, the hash algorithm may be an NIST-based algorithm.

The instructions 604, when executed by the hardware processor, further cause the continuous data protection system to, based on the hashes, determine whether the file is security-compromised. In an example, the file may be security-compromised due to the association of the file with malware. In another example, the file may be security-compromised due to the file having a known, or recognized, security vulnerability. In an example, determining whether the file is security-compromised includes arranging the hashes to form an observed hash sequence and comparing the observed hash sequence to hash sequences contained in a file denylist database. The hashes contained in the file denylist database, in turn, are associated with files that are recognized to have security-related issues. In an example, a particular file identified in the file denylist database has a recognized, or known, security vulnerability. In another example, a file identified by the file denylist database has a known, or recognized, association with malware.

The instructions 604, when executed by the hardware processor, further cause the continuous data protection system to selectively initiate a responsive action based on the determination of whether the file is security-compromised. In an example, the responsive action is the sending of an alert to a user interface. In another example, a responsive action is the sending of a notification to a management controller for the computer system.

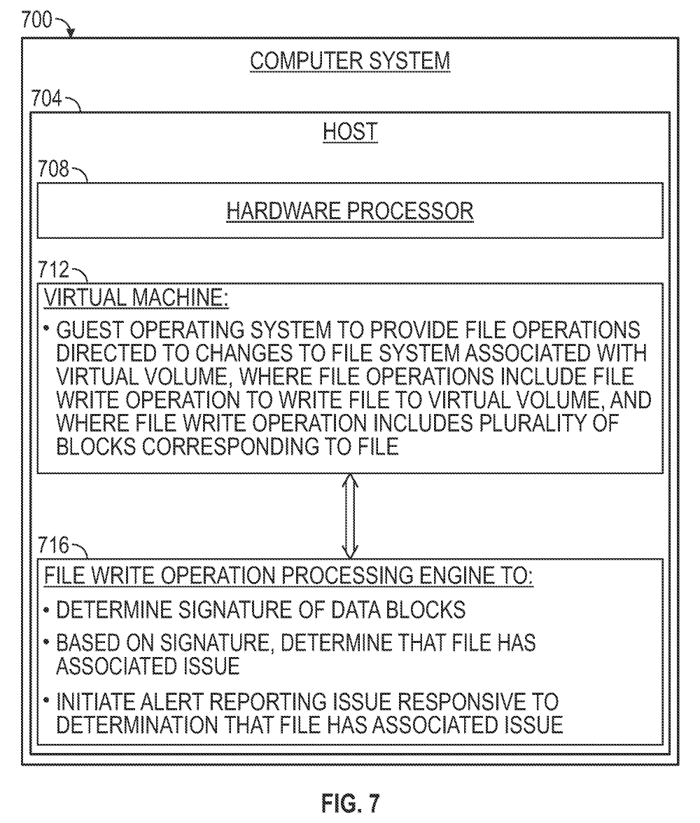

Referring to FIG. 7, in accordance with example implementations, a computer system 700 includes a host 704 that provides, or hosts, a virtual machine 712 and a file write operation processing engine 716. In an example, the computer system 700 is associated with a disaster recovery system. In an example, the computer system and the disaster recovery system are located in different availability zones. In an example, the file write operation processing engine 716 is a virtual replication appliance that sends replicated write operations from the computer system to a virtual replication appliance of the disaster recovery system. In an example, the virtual machine 712 is one of a group of virtual machines hosted on by the computer system and which are part of a virtual protection group. In an example, the virtual machines of the virtual protection group are managed by the same hypervisor. In an example, the file write operation processing engine 716 is a virtual replication appliance, and the virtual replication appliance is a virtual machine that is managed by the same hypervisor that manages the virtual machine 712.

In accordance with example implementations, the host 704 includes a hardware processor 708. In an example, the hardware processor 708 is an actual, or physical, computing resource. In an example, the hardware processor 708 may include one or multiple CPU cores.

The virtual machine 712 includes a guest operating system. In an example, the guest operating system is an abstraction of an operating system of the host 704. The guest operating system provides file operations directed to changes to a file system that is associated with a virtual volume. In an example, the file operations are associated with a SCSI-based storage device protocol. The file operations include file write operations to write a file to the virtual volume, and the file write operations include a plurality of blocks corresponding to the file. In an example, a block corresponds to a cluster. In an example, the block corresponds to content of the file.

The file write operation processing engine 716 determines a signature of the data blocks. In an example, determining the signature includes applying a cryptographic hash algorithm to each data block to derive a hash corresponding the data block, and arranging the hashes in an order to form a hash sequence corresponding to the signature. In an example, the blocks correspond to different portions of the file, and the order of the hashes in the hash sequence corresponds to the order of the portions of the file.

The file write operation processing engine 716, based on the signature, determines that the file has an associated issue. In an example, the file write operation processing engine 716 compares the signature to signatures contained in a file denylist database. In an example, the file denylist database has records, where each record is associated with a file and includes data representing a signature for the file and information about the file. In an example, the files identified by the file denylist database have known, or recognized issues. In an example, the file write operation processing engine 716 determines whether the signature of the data blocks matches a signature contained in the file denylist database. In an example, determining whether the observed signature matches a signature of the file denylist database includes the file write operation processing engine 716 matching one or multiple hashes corresponding to the blocks to one or multiple hashes of a signature contained in the file denylist.

The file write operation processing engine 716 initiates an alert reporting the issue responsive to a determination that the file has an associated issue. In an example, the alert may correspond to a message that identifies a type of the issue. In examples, the type of issue may be a prohibited file, a file having a security-related issue or another issue category. In an example, the alert may identify a time of detection. In another example, the alert identifies the virtual machine 712. In an example, the alert identifies a file name of the file. In an example, the alert identifies a file path of the file.

In accordance with example implementations, the file write operations include respective data units. Determining the observed signature includes determining a hash of a given data unit of the respective data units. Among the potential advantages, the file monitoring architecture detects denylist files in near real time, and the file monitoring architecture is not tied to a specific operating system or operating system version.

In an example, the file write operation targets a virtual volume having an associated cluster size. Each data unit has a size that corresponds to the cluster size. Among the potential advantages, the file monitoring architecture detects denylist files in near real time, and the file monitoring architecture is not tied to a specific operating system or operating system version.

In accordance with example implementations, the file write operations include respective data units. Determining the observed signature includes determining hashes of the respective data units. Among the potential advantages, the file monitoring architecture detects denylist files in near real time, and the file monitoring architecture is not tied to a specific operating system or operating system version.

In accordance with example implementations, the file write operations include respective data units. Determining the observed signature includes determining hashes of the respective data units. Among the potential advantages, the file monitoring architecture detects denylist files in near real time, and the file monitoring architecture is not tied to a specific operating system or operating system version.

In accordance with example implementations, the respective data units are sequenced corresponding to an order in which the data units appear in the file. Determining the observed signature further includes arranging the hashes in a sequence that corresponds to the order. Among the potential advantages, the file monitoring architecture detects denylist files in near real time, and the file monitoring architecture is not tied to a specific operating system or operating system version.

In accordance with example implementations, detecting the issue includes comparing, by the monitoring agent, the observed signature to file signatures that are contained in a file denylist database. Detecting the issue includes determining, by the monitoring agent, whether the observed signature matches any of the file signatures contained in the file denylist database. Among the potential advantages, the file monitoring architecture detects denylist files in near real time, and the file monitoring architecture is not tied to a specific operating system or operating system version.

In accordance with example implementations, initiating the responsive action includes sending, by the monitoring agent and to a user interface, an alert identifying the file and associating the file with the issue. Among the potential advantages, the file monitoring architecture detects denylist files in near real time, and the file monitoring architecture is not tied to a specific operating system or operating system version.

In accordance with example implementations, detecting the issue comprises at least one of detecting that the file is security-compromised, detecting that the file has a software defect, or detecting that the file is associated with a particular file version. Among the potential advantages, the file monitoring architecture detects denylist files in near real time, and the file monitoring architecture is not tied to a specific operating system or operating system version.

In accordance with example implementations, a replication appliance of the computer system sends replications of the file write operations to a recovery system that is associated with the computer system. Among the potential advantages, the file monitoring architecture detects denylist files in near real time, and the file monitoring architecture is not tied to a specific operating system or operating system version.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated recorded items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
accessing, by a hardware processor-based monitoring agent of a computer system, file write operations provided by an operating system of the computer system, wherein the file write operations are associated with a file;
determining, by the monitoring agent, an observed signature of the file based on the file write operations;
based on the observed signature, detecting, by the monitoring agent, an issue associated with the file; and
initiating, by the monitoring agent, a responsive action responsive to the detection of the issue.

2. The method of claim 1, wherein detecting the issue comprises:
comparing, by the monitoring agent, the observed signature to file signatures contained in a file denylist database; and
determining, by the monitoring agent, whether the observed signature matches any of the file signatures contained in the file denylist database.

3. The method of claim 1, wherein:
the file write operations comprise respective data units; and
determining the observed signature comprises determining a hash of a given data unit of the respective data units.

4. The method of claim 3, wherein:
the file write operation targets a virtual volume having an associated cluster size; and
each data unit of the respective data units has a size corresponding to the cluster size.

5. The method of claim 1, wherein:
the file write operations comprise respective data units; and
determining the observed signature comprises determining hashes of the respective data units.

6. The method of claim 5, wherein
the respective data units are sequenced corresponding to an order in which the data units appear in the file; and
determining the observed signature further comprises arranging the hashes in a sequence corresponding to the order.

7. The method of claim 5, wherein:
the file comprises a file content comprising different parts; and
the respective data units comprise all of the different parts.

8. The method of claim 5, wherein the respective data units comprise a subset of data units of the plurality of data units lesser in number than the number of the data units of the plurality data units.

9. The method of claim 1, wherein initiating the responsive action comprises sending, by the monitoring agent and to a user interface, an alert identifying the file and associating the file with the issue.

10. The method of claim 1, further comprising sending, by a replication appliance of the computer system, replications of the file write operations to a recovery system associated with the computer system.

11. A non-transitory storage medium that stores hardware processor-readable instructions that, when executed by a hardware processor, cause a continuous data protection system to:
access file write operations provided by a guest operating system of a virtual machine associated with a computer system, wherein the file write operations are directed to a storage volume of the computer system and wherein the file write operations correspond to a file of the computer system;
replicate the file write operations to provide replicated file write operations;
send the replicated file write operations to a recovery system associated with the computer system;
determine hashes of respective data units of the file write operations, wherein the data units correspond to a file content of the file;
based on the hashes, determine whether the file is security-compromised; and
selectively initiate a responsive action based on the determination of whether the file is security-compromised.

12. The storage medium of claim 11, wherein the instructions that, when executed by the hardware processor, further cause the continuous data protection system to:
determine an observed hash sequence based on the hashes;
compare the observed hash sequence to second hash sequences associated with respective security-compromised files; and
determine whether the file is compromised based on the comparison.

13. The storage medium of claim 11, wherein the instructions that, when executed by the hardware processor, further cause the continuous data protection system to:
determine that file is security-compromised based on the hashes; and
generate a user alert responsive to the determination that the file is security-compromised.

14. The storage medium of claim 11, wherein:
the given file write operation comprise a plurality of data units including the respective data units;
the number of the respective data units is less than the number of the plurality of data units.

15. The storage medium of claim 11, wherein:
the given file write operation comprise a plurality of data units including the respective data units;
the number of the respective data units is the same as the number of the plurality of data units.

16. A computer system comprising:
a host comprising a hardware processor;
a first virtual machine provided by the host, wherein a guest operating system of the first virtual machine to provide file operations directed to changes to a file system associated with a virtual volume, wherein the file operations comprise file write operations to write a file to the virtual volume, and wherein the file write operations comprise a plurality of blocks corresponding to the file;
a file write operation processing engine provided by the host, wherein the file write operation processing engine to:
determine a signature of respective data blocks of the plurality of blocks;
based on the signature, determine that the file has an associated issue; and
initiate an alert reporting the issue responsive to the determination that the file has the associated issue.

17. The computer system of claim 16, wherein the file write operation processing engine comprises a second virtual machine, the computer system further comprising:
a virtual replication appliance to replicate the file operations to provide replicated file operations, and send the replicated operations to a recovery system, wherein the virtual replication appliance comprises the file write operation processing engine; and
a hypervisor to manage the first virtual machine and the second virtual machine.

18. The computer system of claim 16, wherein the file write operation processing engine to further:
determine whether a given block of the plurality of blocks is associated with file attributes or associated with a file content;
responsive to determining that the given block is associated with the file content, determine a hash of the file content; and
determine the signature based on the hash.

19. The computer system of claim 16, wherein the file write operation processing engine to further:
determine hashes of the respective data blocks;
determine an observed hash sequence based on the hashes;
compare the observed hash sequence to second hash sequences of a file denylist; and
determine that the file has the associated issue responsive to a result of the comparison.

20. The computer system of claim 19, wherein the file write operation processing engine to further exclude a given data block from the respective data blocks responsive to the file write operation processing engine determining that the given data block corresponds to an end of the file.
